(19) United States
(12) Patent Application Publication
(10) Pub. No.: US 2009/0299537 A1
(43) Pub. Date: Dec. 3, 2009

(54) METHOD AND SYSTEM FOR PROVIDING ENERGY PRODUCTS

(76) Inventors: ANDREW R. REA, Pasadena, CA (US); Jonathan M. Jacobs, Piedmont, CA (US); Ronald W. Norman, Winchester, MA (US); Jeremiah Johnson, Cambridge, MA (US); R. Mason Smith, Denver, CO (US)

Correspondence Address: DLA PIPER LLP US, P. O. BOX 2758, RESTON, VA, 20195, US

(21) Appl. No.: 12/132,302

(22) Filed: Jun. 3, 2008

(51) Int. Cl. G06F 17/00

(52) U.S. Cl. 700/286

(57) ABSTRACT

A computerized system and method for providing at least one energy product including at least one renewable energy source, the method comprising: receiving electronic data related to renewable energy and non-renewable energy need information for at least one load system; receiving electronic data related to generation output information from at least one renewable energy generator and at least one non-renewable energy generator; and employing at least one computer to compare the electronic data related to the generation output information with the electronic data related to the renewable energy and the non-renewable energy need information to cause the at least one energy product including at least one renewable energy source to be provided to the at least one load system, the at least one computer being other than a computer associated with the at least one load system or the at least one energy generator.

### BRIEF DESCRIPTION OF THE FIGURES

FIG. 1 illustrates a computer system, which can create and/or provide energy products, according to one embodiment.

FIG. 2 illustrates details of an application on the computer system, according to one embodiment.

FIG. 3 illustrates how the application can forecast a system-wide energy output and associated probability distribution from renewable generation sources, according to one embodiment.

FIG. 4 illustrates how the application can forecast a system-wide energy output and associated probability distribution from non-renewable energy sources, according to one embodiment.

FIG. 5 illustrates how a Scheduling Engine(s) can determine potential products to be offered to the Load Systems (LSs), according to one embodiment.

FIG. 6 illustrates details of a Volumetric Accounting Module(s), which helps ensure the accurate accounting of renewable energy, according to one embodiment.

FIG. 7 illustrates how validation can be provided for the renewable energy portion of a blended product through accounting measures for renewable certificates, according to one embodiment.

FIG. 8 illustrates details of an Actualization and Accounting Engine(s), according to one embodiment.

FIG. 9 illustrates details of a Risk Management Engine(s), according to one embodiment.

### DETAILED DESCRIPTION OF EMBODIMENTS

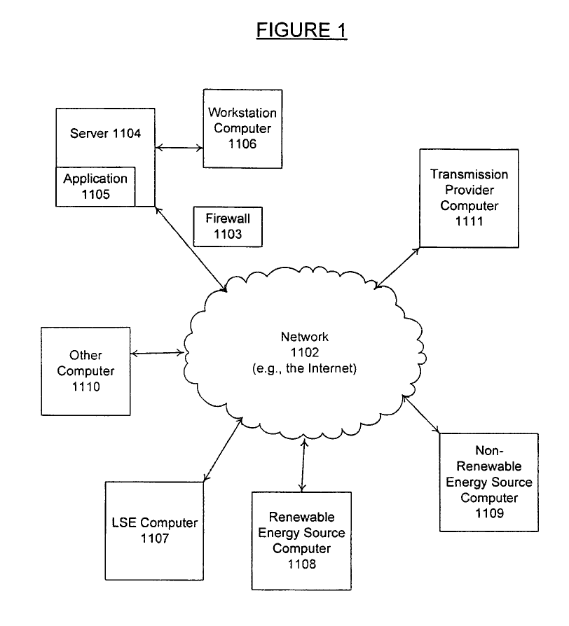

FIG. 1 illustrates a computer system [100], which can create and/or provide energy products, according to one embodiment. The computer system [100] can provide Load Systems (LSs) with blended, certified-renewable energy. Renewable energy sources and non-renewable energy sources can provide energy which can be blended into blended energy products (products blending renewable energy and non-renewable energy) to meet the needs of the LSs. Renewable energy sources can be defined by an entity (e.g., a government entity), and can include, but is not limited to wind energy, solar energy, hydroelectric energy, bio-mass energy, wave power, geo-thermal energy, biogas energy (including landfill gas), waste to energy, wave energy, tidal energy, ocean thermal energy, blue energy (i.e., energy which on salinity gradients), etc. Renewable energy may also be interpreted to include low-carbon and carbon-reducing technologies such as hydro energy, nuclear energy, and load-reducing behaviors such as energy efficiency and demand response. Note that nuclear energy has been included as an example of a renewable energy source because although no state currently recognizes nuclear energy as renewable, nuclear energy can be considered clean or non-carbon intensive. Thus, the renewable energy can include clean or non-carbon intensive energy sources. Similarly, the non-renewable energy can include non-clean or carbon intensive energy sources. Non-renewable energy sources can also be defined by an entity, and can include gas, coal, natural gas, nuclear energy, etc. Emissions data for each of the energy sources can be collected, and weighted average emissions for each blended energy product can be determined. For example, governmental entities (e.g., states, countries) may limit the carbon dioxide emissions for energy sold within the jurisdiction of the governmental entity.

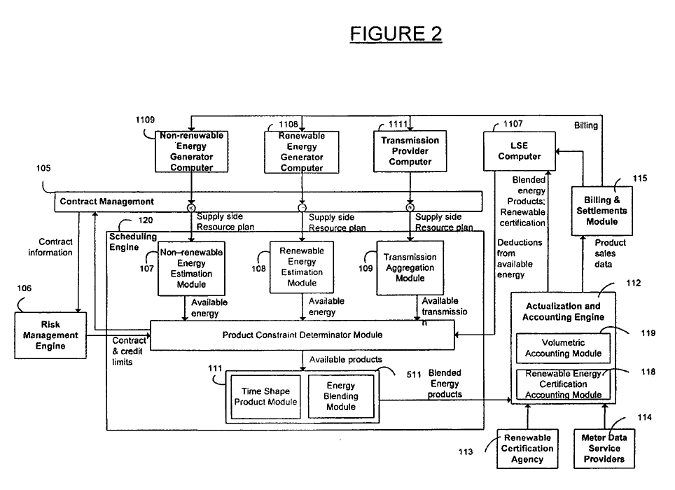

Referring to FIG. 1, information from various sources can be accessed through a network (e.g., the Internet) [1102]. The various sources can include LS computer(s) [1107], renewable energy source computer(s) [1108], non-renewable energy source computer [1109], and other computer(s) [1110], which can also be linked to the system [100]. At least one server [1104] can host these data (e.g., in an application server cluster farm). At least one application [1105] can be accessed by the server [1104] and the various computers to create and/or provide energy products. Based on the needed energy amount and appropriate blend as specified by the LS computer [1107], server [1104] can cause renewable energy source computer 108 and non-renewable energy source computer 109 to cause appropriate energy to be delivered to the LS(s). Note that the application [1105] is described in more detail with respect to FIG. 2, explained below. A firewall [1103] can protect the server [1104]. Workstation computers [1106] can allow internal participants to link to server [1104]. Transmission provider computers [1111] can provide data on transmission availability.

The computer system [100] can employ a multi-tiered architecture with the ability of distributed computing to allow for real-time performance and scalability. The computer system [100] can run on a clustered network model, and can incorporate load balancing and grid computing, to yield high-performance and failovers for real-time environments. Various forecast and aggregation modules can be run on a middleware-based distributed environment to perform simulations and yield faster results.

The computer system [100] can comprise a number of data interfaces that allow all the modules and engines in the computer system [100] to operate together as an ecosystem in order to derive the optimal blended energy schedule in a real-time environment. The data interfaces can also include communication to the external or third party services such as renewable energy credit systems, market data, and meter data services.

The computer system [100] can include Graphical User Interfaces [GUIs], which can allow users to enter and manage information, such as contracts that have been signed with various LS, renewable energy generators, and non-renewable energy generators.

The server [1104] can include databases to store all contract, scheduling, accounting, and risk management data. Databases can also store historic simulations and forecasts, historic and forward market data, meter data, and weather data. Multiple logical and physical databases can be defined to segregate the data access and data performance between market data, reference data, and transactional (contract) data.

FIG. 2 illustrates details of the application [1105], according to one embodiment. FIG. 2 illustrates the relationship and interactions between the sub-components of the application [1105]. Data containing the amount and time shape of the available non-renewable energy can be sent from a Non-renewable Energy Generator computer(s) [1109] to a Non-renewable Energy Estimation Module(s) [107]. Data containing the amount and time shape of renewable energy from renewable energy generators can be sent from a Renewable Energy Generator computer(s) [1108], in some embodiments coupled with renewable certification identification information, to a Renewable Energy Estimation Module(s) [108]. Data on transmission availability can be sent from a Transmission Provider computer(s) [1111] to a Transmission Aggregation Module(s) [109]. Information on the contracts between a third party entity (e.g., such as one controlling the application [1105], generators and transmission providers can be controlled by a Contract Management Module(s) [105]. Data can be sent from the Contract Management Module(s) [105] to a Risk Management Engine(s) [106], which can quantify and minimize the commodity, term, and credit risks. The Non-renewable Energy Estimation Module(s) [107], the Renewable Energy Estimation Module(s) [108], and the Transmission Aggregation Module(s) [109] can each provide an indication of the amount of energy from each source that is available. The Product Constraint Determinator Module(s) [110] can aggregate the available renewable and non-renewable energy, as constrained by generator capabilities, transmission access, and contract and credit limits. Using long-term forecasts from the Renewable Energy Estimation Module(s) [108], the Product Constraint Determinator Module(s) [110] can inform the Contract Management Module(s) [105] of yearly supply expectations from renewable sources. This allows for “inventory control,” such as the acquisition of the correct amount of contracted renewable capacity to ensure the availability of renewable energy for future blended products. LS computers [1107] then can receive products from the available pool of energy as compiled by the Product Constraint Determinator Module(s) [110]. These products can be created using the Time Shape Product Module(s) [111] and the Energy Blending Module(s) [111], matching the LSs' demand with various characteristics (e.g., time shape and renewable content). Once created, the energy in these products can be removed from the pool of available energy, as shown by the Product Constraints Determinator Module(s) [110], which can help ensure updated and accurate product availability on a real-time basis.

After the energy product is created, the Actualization and Accounting Engine(s) [112] can be used to help ensure the actual amount of received renewable energy matches stated product contents and that appropriate renewable energy certificates are received. The Volumetric Accounting Module(s) [119] can minimize surpluses or deficits in delivered renewable energy and can account for over-delivery or over-payment. A Meter Data Service Provider(s) [114] can send accurate energy production data. A Renewable Certification Agency(ies) [113] and a Renewable Energy Certification Accounting Module(s) [118] can be used to input information regarding proper accreditation of renewable energy. A Billing and Settlements Module(s) [115] can help ensure that proper charges and payments are issued to each counter-party, based on contract terms and delivery energy. Upon delivery of the energy products, the LSs can also receive information about the renewable energy content of the product, any associated renewable energy certificates, and a report which characterizes the weighted average emissions levels for their blended product.

Product definition and constraint GUIs can allow definition of custom products such as seller-scheduled, block-shaped and load-following products with their schedules.

In one embodiment, the application [1105] can rely on short-term (e.g., per minute, hourly) and longer-term (e.g., daily, weekly, monthly, semi-annually, annually) forecasts for energy output for each subscribed intermittent generator. Geographical diversity of these generators can reduce the system-wide effect of intermittency. For example, if the wind is not blowing in Location A, it may still be blowing in Location B. Relying on the net result of the all forecasting in all relevant geographical areas, the application [1105] can provide an expected output of renewable energy over time.

Renewable Portfolio Standards (RPSs) typically require an annual total amount of renewable energy. Variations in the output of intermittent resources can cause variations in the renewable energy content of the provided products. In one embodiment, application [1105] can serve as an accounting tool, tracking the actual renewable energy delivered and ensuring that, averaged over time, the LS receives precisely the amount of renewable energy that it purchased. In instances where a deficit or surplus of renewable energy was delivered, application [1105] can ensure that proper credits or debits are given to the consumer. In one embodiment, application [1105] can also track the renewable energy certificates or other methods of validating the renewable content of the energy. This tracking mechanism will be used to ensure that the LSs receive proper regulatory credit for the renewable energy which they purchase. In addition, in order to help ensure the long-term availability of renewable resources to the computer system [100], extended renewable supply forecasts can be employed to manage the quantity and type of contracted capacity (i.e., inventory control).

Because there is no ability to control when some generating units generate energy, the application [1105] can also forecast production and plan generation from dispatchable units (e.g., a natural gas combined cycle plant that can effectively produce electricity as needed) to properly time shape the energy products which are sent to the LSs.

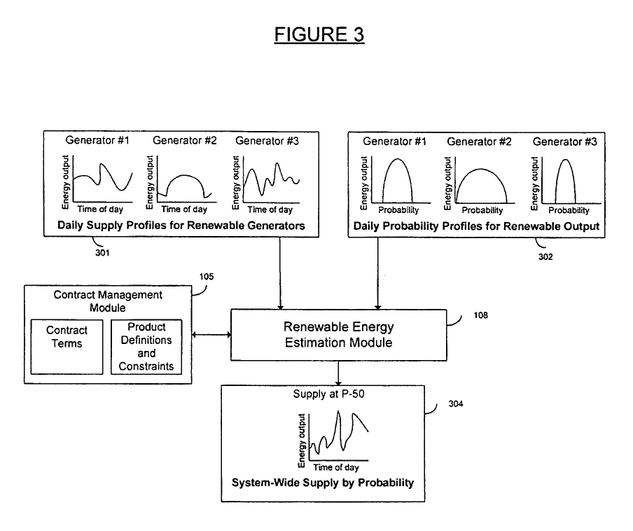

FIG. 3 illustrates how application [1105] can forecast a system-wide energy output and associated probability distribution from renewable generation sources, according to one embodiment. Current and future daily supply profiles [301] for each generating unit through corresponding Renewable Energy Generator computer(s) [1108] can be created based on weather forecast modeling and expected unit performance. These data, which should cover short-term expectations for several days into the future and long-term expectations for several years into the future, can be entered in the Renewable Energy Estimation Module(s) [108]. Forecasts can be updated as new or different information becomes available. This calculation can be informed by the contract terms related to the amount of energy required, and the associated product definitions/constraints, as managed using the Contract Management Module(s) [105].

Using long-term forecasts from the Renewable Energy Estimation Module(s) [108], the Contract Management Module(s) [105] can receive information on the expected yearly supply expectations from renewable sources. This allows the Contract Management Module(s) [105] to handle “inventory control,” namely the acquisition of the correct amount of contracted renewable capacity to ensure the availability of renewable energy for future blended products.

The probability of occurrence for the daily supply profiles [302] for each of the units through corresponding Renewable Energy Generation computer(s) [1108] can also be entered into the Renewable Energy Estimation Module(s) [108]. Other unit characteristics, such as total capacity and expected outages, can also be entered and stored using application [1105]. Using statistical modeling, the Renewable Energy Estimation Module(s) [108] can produce a probability-weighted expected daily supply shape [304] for several forecasting periods (e.g., several days into the future, yearly output). For daily probability profiles [302], the minimum likelihood of occurrence (selecting from a range of probabilities (e.g., P-1 (1% probability) to P-99 (99% probability)) can be selected, as given by “P” in Equation 1 below. Equation 1 is used to calculate the system-wide renewable output for a series of time, given the user-defined probability of occurrence. As better data become available, the Renewable Energy Estimation Module(s) [108] can update these supply shapes and probability curves. These system-wide supply shapes and probability curves can be useful for planning which products can be offered to the LSs, including the total renewable content and the time shape of the energy output. By calculating the system-wide supply shapes, the benefits of geographical diversity can also be quantified.

$${REO}_{T} \text{:} ( {\sum }_{A = 1}^{X} {Ω}_{A , T} {Φ}_{T , P} ) * Λ \qquad ( Equation 1 )$$

REO_{T}=renewable expected output at time T
A=the renewable energy generating unit number
X=the total number of renewable energy generating units
Ω=the renewable energy capacity (in mega watts (MW)) for the generating unit
φ=the expected output of the generating unit as a percent of total capacity given a defined likelihood of occurrence
Λ=a optional derating synergistic factor used to dampen the probabilities of occurrence for use with heterogeneous renewable generating units
T=the time of occurrence
P=the user-defined probability of occurrence

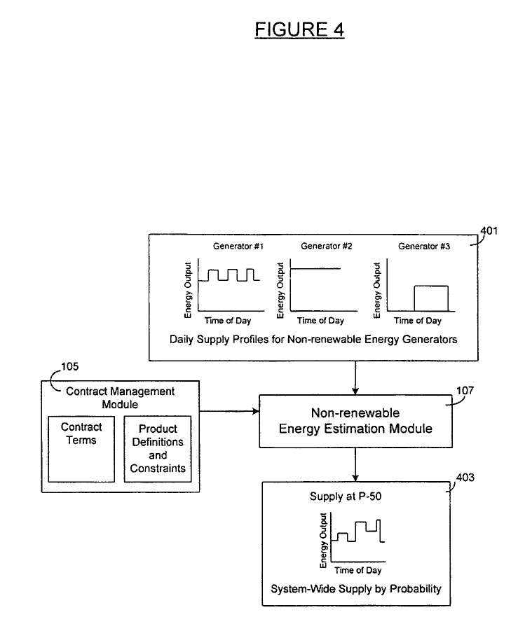

FIG. 4 illustrates how application [1105] can forecast a system-wide energy output and associated probability distribution from non-renewable energy sources, according to one embodiment. Because traditional non-renewable energy generation is dispatchable, intermittency is not an issue the way it is with some renewable energy, and any unpredictability is primarily limited to plant outages. For each non-renewable energy generator, the expected daily supply profiles [401] can be aggregated in the Non-renewable Energy Estimation Module(s) [107] through corresponding Non-Renewable Energy Generator computer(s) [1109]. The output is combined with contracted-for amounts of non-renewable energy from contract manager [105] to produce a system-wide non-renewable energy supply profile and the probability of occurrence as informed by outage rates [403], as illustrated in Equation 2 below.

$${NEO}_{T} \text{:} {\sum }_{B = 1}^{Z} {Γ}_{B , T} {Ψ}_{T} \qquad ( Equation 2 )$$

NEO_{T}=non-renewable expected output at time T
B=the non-renewable energy generating unit number
Z=the total number of non-renewable energy generating units
Γ=the non-renewable energy capacity (in MW) for the generating unit
ψ=the estimated available output of the generating unit as a percent of total capacity given planned and forced outages
T=the time of occurrence

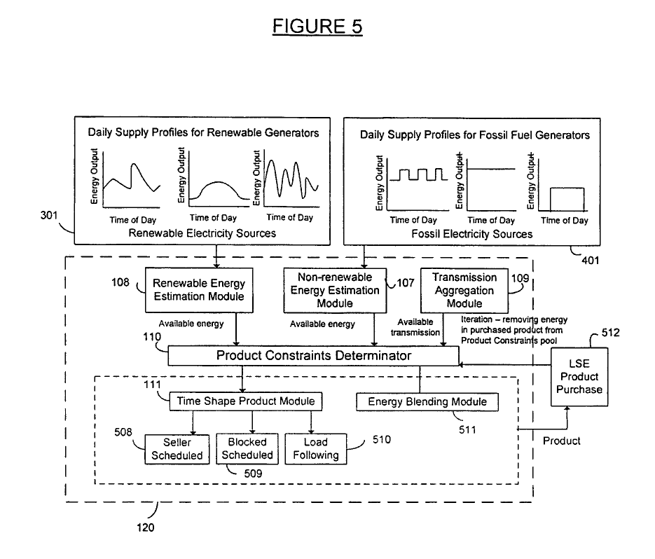

FIG. 5 illustrates how the Scheduling Engine(s) [120] can determine potential products to be offered to the LSs, according to one embodiment. The Scheduling Engine(s) [120] can determine product constraints based on generator output and transmission constraints, and then can structure the products based on their time shape and renewable energy content. One objective of the Scheduling Engine(s) [120] is to seamlessly and accurately create blended energy products—working within the constraints of the available supply—that meet the demands of LSs. The Scheduling Engine(s) [120] can determine what the aggregate available supply profile is by time and quantity, net out supply committed to current LS contracts, and determine what combinations of future supply remain available.

The supply side resource profiles for renewable energy [301] can be provided to the Renewable Energy Estimation Module(s) [108], while the supply profiles for non-renewable energy generation [401] can be provided to the Non-renewable Energy Estimation Module(s) [107]. The system-wide renewable generation and non-renewable generation estimations can be calculated based on this data and calibrated through modeling techniques which incorporate weather forecasting for renewable generation. The output of this process can be the potential available energy on a weekly, daily, hourly, and real-time basis. This calculation can be continuously updated as data change.

The Product Constraints Determinator [110] uses this information to determine the potential suite of products that are available for purchase. This pool of products is limited by transmission constraints, as determined by the Transmission Aggregation Module(s) [109]. The output of this process can be an interactive report which details the range of potential products that can be offered to each LS, including limitations on renewable content by type of generator and the time shape of the product.

The Energy Blending Module [511] can use a rule-based optimization algorithm to determine the optimal blended energy sources and can analyze various constraints at different levels, such as total load requirements, total generation fuel mix (e.g., gas, coal, wind), and individual contract requirements (e.g., 10% annual renewable content). As each product for each LS is defined, selected, and delivered, the associated energy can be removed from the available pool of energy and the Product Constraints Determinator [110] can be run again, providing a different set of outputs and a new report. The Product Constraints Determinator [110] can iteratively update the available pool of energy, including its time and renewable attributes, giving the LSs new boundary conditions on the products they may purchase. The finalized generation and transmission requirements can then be communicated back to non-renewable energy generators and transmission providers.

When LSs are under a contract, the computer system [100] can thus optimize how their contract is fulfilled using a load balancing mechanism which maximizes the selling power, which can be incorporated in the Product Constraints Determinator [110]. In one embodiment, the LSs (e.g., buyers) can determine the type of energy product which they receive.

A first consideration can be the renewable content of the product, which can range from 0% to 100%. The consumer can choose a product with a share of renewable energy (and the correct type of renewable energy) as needed to meet their renewable energy demand at the most cost effective price. The correct amounts of energy can be blended from subscribed energy generation providers to create the products required.

A second consideration can be the tenor (or length) of the contract that the LS wishes to sign up for. LSs may want the flexibility of short-term contracts for the blended energy products or they may prefer the cost advantage and long-term security of longer contracts. Because renewable energy generators may require longer term contracts to secure funding, when an LS purchases products based on short-term contracts, term risk is introduced. This term risk can be quantified by tracking and characterizing both supply and demand contracts, and can be calculated the appropriate risk premium that should be charged.

A third consideration which can define an energy product is a time-shape of the product. Because the current capacity for energy storage in a country's (e.g., the United States') electrical grid can be minimal, energy generation must equal energy demand on a temporal basis. Several of the most prominent renewable energy technologies are non-dispatchable (i.e., the amount of energy they generate at a given time is determined by outside forces). This is true, as examples, for wind power and solar generating technologies. In one embodiment, this problem can be mitigated by blending intermittent energy with dispatchable energy. LSs can choose energy products with time shapes including seller scheduled energy, block shaped energy, and load following energy.

The time shape parameters for the LSs can be input into the Time Shape Product Module(s) [111]. Using drop down menus, the potential selections include three choices for the shape: 1. Seller Scheduled [508] products, which can roughly follow the natural output of the renewable generating sources; Block Scheduled [509] products, which can provide the LS with the option to select discrete quantities of energy to be provided over several pre-defined time blocks throughout the day; and Load Following [510] products, which can allow the LS to define the amount of energy the LS receives on a more frequent basis.

It should be noted that time-sensitive critical information can be fed to the Energy Blending Module(s) [511] and Time Shape Product Module(s) [111]. For example, various (possible) inputs and outputs can be defined to the Non-renewable Energy Estimation Module(s) [107], the Renewable Energy Estimation Module(s) [108]; and the Transmission Aggregation Module(s) [109]. The Energy Blending Module(s) [511] and Time Shape Product Module(s)s [111] can take renewable energy production estimates, fuel energy production estimates, individual load requirements from contracts, and transmission availability, and can apply a rule-based optimization algorithm in order to generate the optimal blended energy schedule.

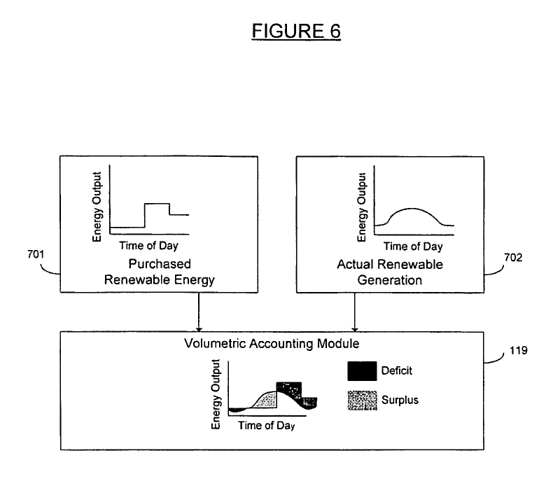

FIG. 6 illustrates details of a Volumetric Accounting Module(s) [119], which helps ensure the accurate accounting of renewable energy, according to one embodiment. Forecasts of intermittent renewable energy generation are unlikely to be 100% accurate. When LSs order a product containing renewable energy, they expect the products to contain an accurate share of such energy. Fortunately, typical RPS targets are based on a yearly quantity of renewable energy. This allows the application [1105] to provide higher proportions of renewable energy in products at a later date to “catch up” for any products that failed to achieve their renewable energy content. Conversely, the application [1105] could also provide lower proportions of renewable energy in products when overproduction has previously occurred.

Data can be entered into the Volumetric Accounting Module(s) [119] which describes the expected renewable content each product delivered to each LS [701]. Since these products were based on the output of the Renewable Energy Estimation Module(s) [108], any error in the renewable energy generation forecasting could result in a deviation from the expected renewable content of each product. Data for the actual level of renewable energy generation [702] has already been entered into the Volumetric Accounting Module(s) [119]. Using the Volumetric Accounting Module(s) [119], the difference between the renewable energy deficit and the surplus over time can be calculated. These results can then inform the Product Constraint Determinator [110] when surpluses or deficits of renewable energy exist so that it will adjust its current product mix accordingly to eliminate such surpluses or deficits.

The formulas listed below can be used in the Volumetric Accounting Module(s) [119].

MIN|{Σ(Deficit)−Σ(Surplus)}| Eq. 3

IF{Σ(Deficit)−Σ(Surplus)}>0,THEN{Σ(Deficit)−Σ(Surplus)}=(Over Payment) Eq. 4

IF{Σ(Surplus)−Σ(Deficit)}>0,THEN{Σ(Surplus)−Σ(Deficit)}=(Over Delivery) Eq. 5

Governed by Equation 3, the Volumetric Accounting Module(s) [119] can work to minimize the net difference between the sum of the surpluses and the sum of the deficits. Some instances may exist when a surplus or deficit cannot be balanced out. Such times may include end of the year operations and occasions when an LS ends its relationship with the application [1105]. If a deficit cannot be eliminated by providing a surplus of renewable energy at a later date, the Volumetric Accounting Module(s) [119] can calculate the amount of over-payment, as governed by Equation 4. If a surplus remains, Equation 5 can describe the calculation of over-delivery.

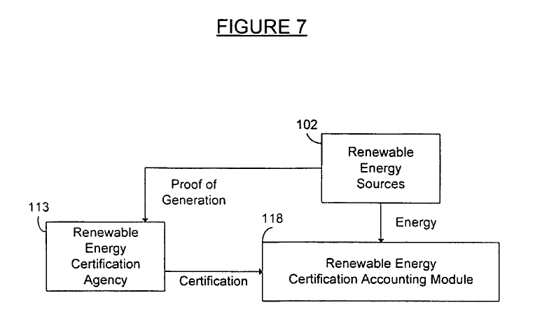

FIG. 7 illustrates how validation can be provided for the renewable energy portion of a blended product through accounting measures for renewable certificates, according to one embodiment. An independent renewable energy certification agency [113] can be incorporated to ensure that LSs are given credit for the renewable energy content of the products purchased through the computer system [100]. Renewable energy generators can still sell their product through the computer system [100]. The renewable energy is certified by an independent renewable energy certification agency [113] which can verify that it meets many regulatory requirements to satisfy renewable portfolio standards and other renewable energy requirements. The Renewable Energy Certification Accounting Module(s) [118] can track the renewable certification throughout the blending and shaping process. It also provides the LSs with a prorated number of renewable energy certificates based on the renewable content of the products which they purchase.

The Renewable Energy Certification Accounting Module(s) [118] can require the user to enter data into a GUI. Data required can include the renewable energy certification identification numbers, the generating source, and the amount of energy generated. Upon entering this data, the model can “tag” each unit of renewable energy. This tag can follow the energy through the blending and shaping processes. Upon delivery of the energy to the LS, the Renewable Energy Certification Accounting Module(s) [118] can produce a summary report of all renewable energy certificates that the LS should receive and work with the certifying agency to ensure they are sent to the LS.

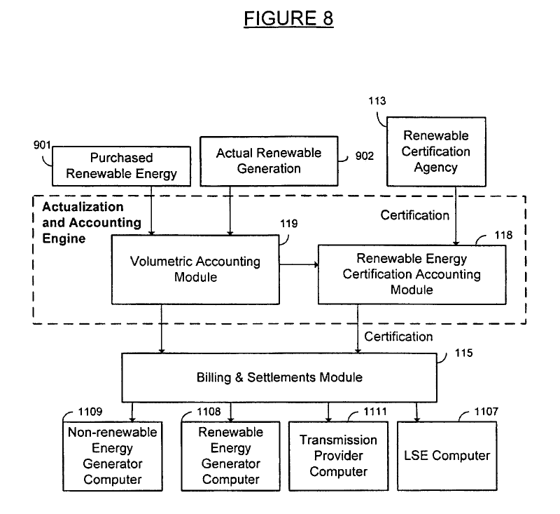

FIG. 8 illustrates details of an Actualization and Accounting Engine(s) [112], according to one embodiment. The Actualization and Accounting Engine(s) [112] can track the scheduled and actualized volume of physical energy for both non-renewable and renewable energy for accurate accounting, as well as tracking renewable energy certification. Data describing the purchased renewable energy [901] and the actual renewable energy generation [902] can be fed into the Volumetric Accounting Module(s) [119]. As discussed above, this module minimizes surplus, deficits, and accounts of over-payment or over-delivery using Equations 3, 4, and 5. This information informs the Billing and Settlements Module(s) [115], which can be used for generating monthly or weekly invoices, and payment statements (depending on the contract terms) including net out statements to LS computer(s) [1107] renewable energy source computer(s) [1108], non-renewable energy source computer(s) [1109] and/or transmission provider computer(s) [1111].

As the meter data information (i.e., actual delivered energy) is made available within the month, the volume can be tracked as best-available actualized volume. At the end of a month, as the counterparty checkout processes are performed and more accurate meter data is made available, the volume can be tracked as the actualized volume. This volumetric information can be supplied to the Volumetric Accounting Module(s) [119] for renewable energy surplus and deficit accounting. The surplus and deficit accounting mechanism can use Equations 3, 4, and 5 to calculate what has been assigned and what the variance is for a given time period.

The volume can also be tracked at a fuel mix level in order to facilitate the emissions tracking and reporting for each contract and time period. This can be done to ensure that the LSs are not serving a load with a mix which is not approved by certain state or local agencies. This can also ensure that the non-renewable energy generators are not over their annual allocation burn targets. The tracked scheduled and actualized volumes can be used for regression analysis for analyzing the variance between the forecast and actual load.

The Renewable Energy Certification Accounting Module(s) [118] can generate a renewable energy credit tracking statement in order to track the renewable energy requirement and verify delivery to ensure the counterparties get the appropriate credits as proof for the government agencies. Certification can be provided by an outside Renewable Certification Agency [113].

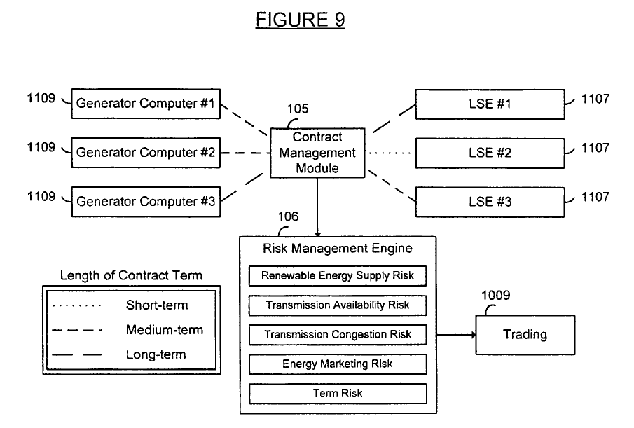

FIG. 9 illustrates details of a Risk Management Engine(s) [106], according to one embodiment. The Risk Management Engine(s) [106] can quantify numerous faced risks, providing information so that the contract pricing can fairly incorporate this risk. Details on the contract terms for each of the generator computers [1108-1109] and LSs [1007] can be entered into the Contract Management Module(s) [105]. The Contract Management Module(s) [105] can act as a central repository for all counterparties and contracts. All general terms pertaining to the contract can be captured in the application [1105]. Specific data such as renewable requirements, non-renewable energy mixes, and time constraints that are required as part of the decision-making process for optimal dispatch can be recorded.

The Risk Management Engine(s) [106] can quantify the following types of risk: renewable energy supply risk, transmission availability risk, transmission congestion risk, energy marketing risk, and term risk For each type of risk, data can be produced which can inform contract pricing strategies to be used in trading 1009.

The renewable energy supply risk can estimate the supply availability into the future, can work with the Contract Management Module(s) [105] to help ensure the adequacy of future supply, can inform the shaping of products to stay within supply at high probability, or can determine penalties for generator non-compliance, or any combination thereof. The transmission availability risk can cover the risk that a transmission may not get built in the expected time frame, and that development may subsume the available transmission capacity. Transmission congestion risk can quantify the risk of high cost transmission due to congestion. Energy marketing risk can include price risk, technology risk, and credit risk. The price risk management of energy marketing is a standard concept, which can be included in energy marketing risk. Because emerging technologies can be utilized, the risk for poor performance, the failure to meet performance targets, or difficulties in manufacturing can be captured in the technology risk.

The Risk Management Engine(s) [106] can track all counterparty ratings, review credit, and monitor limits. It can also provide the collateral management that incorporates various collateral such as letters of credit, guarantees, bonds, and prepays. The collateral and credits can be evaluated on a daily basis for determining counterparty margin needs and tracking potential future exposure.

The application [1105] can facilitate agreements with numerous generators and LSs. The terms of each of these agreements can vary, including the length of the contract term. The potential exists for the length of the contract terms to vary significantly. For example, LSs could require short- and medium-term contracts while developers could require predominately medium- and long-term contracts. This could introduce term risk into the application [1105], where its commitments for supply do not match its obligations for demand. The term risk manager can calculate the risk associated with disparities between contract length for generators and LSs. Should generators require longer (or shorter) term contracts, term risk could be introduced.

The Risk Management Engine(s) [106] can also quantify each of the risk areas and issue daily reports, which can help make trades in the interest of hedging this risk. Daily activity can be filtered back to the Risk Management Engine(s) [106] on a daily basis, thus allowing for up-to-date risk accounting.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. In fact, after reading the above description, it will be apparent to one skilled in the relevant art(s) how to implement the invention in alternative embodiments. Thus, the present invention should not be limited by any of the above described exemplary embodiments.

In addition, it should be understood that any figures, screen shots, tables, examples, etc. which highlight the functionality and advantages of the present invention, are presented for example purposes only. The architecture of the present invention is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

Furthermore, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

1. A computerized method for providing at least one energy product including at least one renewable energy source, the method comprising:
receiving electronic data related to renewable energy and non-renewable energy need information for at least one load system;
receiving electronic data related to generation output information from at least one renewable energy generator and at least one non-renewable energy generator; and
employing at least one computer to compare the electronic data related to the generation output information with the electronic data related to the renewable energy and the non-renewable energy need information to cause the at least one energy product including at least one renewable energy source to be provided to the at least one load system, the at least one computer being other than a computer associated with the at least one load system or the at least one energy generator.

2. The method of claim 1, wherein the generation output information includes energy amount information and/or time shape information.

3. The method of claim 1, wherein an amount of renewable energy and non-renewable energy to be delivered is estimated.

4. The method of claim 3, wherein the estimated amount of renewable energy and non-renewable energy is a long-term supply estimation.

5. The method of claim 3, wherein the estimated amount of renewable energy and non-renewable energy accounts for inventory supply expectations of the at least one renewable energy generator and/or the at least one non-renewable energy generator.

6. The method of claim 3, wherein the estimated amount of renewable energy and non-renewable energy meets renewable energy certification requirements.

7. The method of claim 1, wherein the at least one energy product is customized for the at least one load system.

8. The method of claim 7, wherein the customization includes at least one seller-scheduled component, at least one block-scheduled component, or at least one load-following component, or any combination thereof.

9. The method of claim 1, wherein outages are predicted.

10. The method of claim 1, wherein the estimated amount of renewable energy and non-renewable energy accounts for risk information.

11. The method of claim 9, wherein the risk information comprises: commodity risk, term risk, or credit risk, or any combination thereof.

12. The method of claim 3, wherein the estimated amount of renewable energy and non-renewable energy minimizes surpluses or deficits in delivered renewable energy and/or accounts for over-delivery or over-payment.

13. The method of claim 3, wherein the estimated amount of renewable energy and non-renewable energy accounts for probability-weighted forecasting.

14. The method of claim 3, wherein the estimated amount of renewable energy and non-renewable energy can be continuously updated.

15. A computerized system for providing at least one energy product including at least one renewable energy source, the system comprising:
at least one server coupled to at least one network;
at least one user terminal coupled to the at least one network;
at least one application coupled to the at least one server and/or the at least one user terminal, wherein the at least one application is configured for:
receiving electronic data related to renewable energy and non-renewable energy need information for at least one load system;
receiving electronic data related to generation output information from at least one renewable energy generator and at least one non-renewable energy generator; and
employing at least one computer to compare the electronic data related to the generation output information with the electronic data related to the renewable energy and the non-renewable energy need information to cause the at least one energy product including at least one renewable energy source to be provided to the at least one load system, the at least one computer being other than a computer associated with the at least one load system or the at least one energy generator.

16. The system of claim 15, wherein the generation output information includes energy amount information and/or time shape information.

17. The system of claim 15, wherein an amount of renewable energy and non-renewable energy to be delivered is estimated.

18. The system of claim 17, wherein the estimated amount of renewable energy and non-renewable energy is a long-term supply estimation.

19. The system of claim 17, wherein the estimated amount of renewable energy and non-renewable energy accounts for inventory supply expectations of the at least one renewable energy generator and/or the at least one non-renewable energy generator.

20. The system of claim 17, wherein the estimated amount of renewable energy and non-renewable energy meets renewable energy certification requirements.

21. The system of claim 15, wherein the at least one energy product is customized for the at least one load system.

22. The system of claim 21, wherein the customization includes at least one seller-scheduled component, at least one block-scheduled component, or at least one load-following component, or any combination thereof.

23. The system of claim 15, wherein outages are predicted.

24. The system of claim 15, wherein the estimated amount of renewable energy and non-renewable energy accounts for risk information.

25. The system of claim 24, wherein the risk information comprises: commodity risk, term risk, or credit risk, or any combination thereof.

26. The system of claim 17, wherein the estimated amount of renewable energy and non-renewable energy minimizes surpluses or deficits in delivered renewable energy and/or accounts for over-delivery or over-payment.

27. The system of claim 17, wherein the estimated amount of renewable energy and non-renewable energy accounts for probability-weighted forecasting.

28. The system of claim 17, wherein the estimated amount of renewable energy and non-renewable energy can be continuously updated.
